(19) United States
(12) Patent Application Publication
(10) Pub. No.: US 2005/0109522 A1
(43) Pub. Date: May 26, 2005

(54) Conductive TEFLON film tape for EMI/RFI shielding and method of manufacture

(75) Inventor: Floyd Ysbrand, Joplin, MO (US)

Correspondence Address: NIXON & VANDERHYE, PC, 1100 N GLEBE ROAD, 8TH FLOOR, ARLINGTON, VA, 22201-4714, US

(73) Assignee: Midcon Cables Co., L.L.C., Joplin, MO

(21) Appl. No.: 10/720,685

(22) Filed: Nov. 25, 2003

(51) Int. Cl. H01B 7/29

(52) U.S. Cl. 174/36

(57) ABSTRACT

A conductive tape for the manufacture of shielded electrical wire to provide a positive attenuation of and protection from electromagnetic and radio frequency interference. The tape has an outer insulation layer formed of PTFE and an inner conductive layer formed of metallic powder dispersed in PTFE. The conductive tape is spirally wound and cured on insulated wire to form the shielded electrical wire. The tape may have additional insulation or conductive layers.

### FIELD OF THE INVENTION

The present invention relates to a new and improved conductive tape for use in the manufacture of shielded electrical wire to provide a positive attenuation of and protection from electromagnetic and radio frequency interference, and to a method of manufacturing such conductive tape.

### BACKGROUND OF THE INVENTION

Up to the present time, electric wire has been provided with metal braiding, tapes, foils or the like in order to provide a positive attenuation of and protection from electromagnetic and radio frequency interference. Such shielded wire has been complicated in construction, expensive to manufacture, relatively rigid, high in weight and large in diameter.

The new and improved conductive tape and shielded electrical wire construction of the present invention are not subject to any of the disadvantages of previously used shielded wire and possess certain advantages not found in previously used wire.

It is a primary object of the present invention to provide a new and improved conductive tape and method of manufacturing same for use in the manufacture of shielded electrical wire.

It is a further object of the present invention to provide a shielded electrical wire construction and method of manufacturing same which utilizes the new and improved conductive tape, wherein the shielded wire is simple in construction, inexpensive to manufacture, light in weight, small in diameter and of improved flexibility compared to previously used shielded wire.

### SUMMARY OF THE INVENTION

In accordance with the present invention, insulated electrical wire of any suitable type is provided with a conductive tape on the outer surface thereof to provide a positive attenuation of and protection from electromagnetic and radio frequency interference. The conductive tape comprises an inner layer of a metallic powder of copper, iron, nickel, aluminum, silver, gold or carbon, alone or in any desired mixture. The powder is blended into a liquid dispersion coating of polytetrofluoroethylene (PTFE), generally known under the trademark TEFLON, or blended into a PTFE liquid striping ink, in a ratio that, when cured at sufficient temperature, provides a conductive surface that bonds to the wire.

The conductive tape comprises an outer insulation layer of PTFE and is spirally wrapped around the wire and then drawn through a heated metal compression sealer or the like to provide the insulation and conductive coating on the wire.

The PTFE tape may have conductive coatings on the inner and/or outer surfaces thereof, and may have another insulating coating disposed over a conductive coating on the outer surface thereof to protect it.

The new and improved shielded electrical wire construction of the present invention is simple in construction, inexpensive to manufacture, light in weight, small in thickness and of improved flexibility compared to previously used shielded wire utilizing metal tapes, braids, foils or the like. Weight saving is particularly important in view of the stringent requirements for present day, lightweight space in various environments, such as aeronautical environments.

### BRIEF DESCRIPTION OF THE DRAWINGS

FIG. 1 is a side elevational view of a portion of a first embodiment of the conductive tape of the present invention;

FIG. 2 is a perspective view of a portion of a shielded electrical wire constructed in accordance with a first embodiment of the present invention, with parts broken away, using the conductive tape shown in FIG. 1;

FIG. 3 is a schematic view of a first embodiment of apparatus for manufacturing the shielded electrical wire with the tape shown in FIG. 1;

FIG. 4 is a side. elevational view of one embodiment of a first portion of the apparatus for manufacturing the coated PTFE tape shown in FIG. 1;

FIG. 5 is a top elevational view of the apparatus shown in FIG. 4;

FIG. 6 is a schematic view of one embodiment of a second portion of the apparatus for manufacturing the PTFE tape shown in FIG. 1;

FIG. 7 is a side elevational view of a portion of a second embodiment of the conductive tape of the present invention;

FIG. 8 is a side elevational view of apparatus for manufacturing the PTFE tape shown in FIG. 7;

FIG. 9 is a side elevational view of a portion of a third embodiment of the conductive tape of the present invention;

FIG. 10 is a side elevational view of apparatus for manufacturing the PTFE tape shown in FIG. 9;

FIG. 11 is a side elevational view, with parts broken away and parts in section, of a shielded electrical wire with the PTFE tape shown in FIG. 1 spirally wrapped thereon;

FIG. 12 is a side elevational view, with parts broken away and parts in section, of a shielded electrical wire with the PTFE tape of FIG. 9 spirally wrapped thereon; and

FIG. 13 is a schematic view of a further embodiment of apparatus for manufacturing shielded electrical wire with the conductive tapes shown in FIGS. 1, 7 or 9.

### DESCRIPTION OF THE PREFERRED EMBODIMENTS

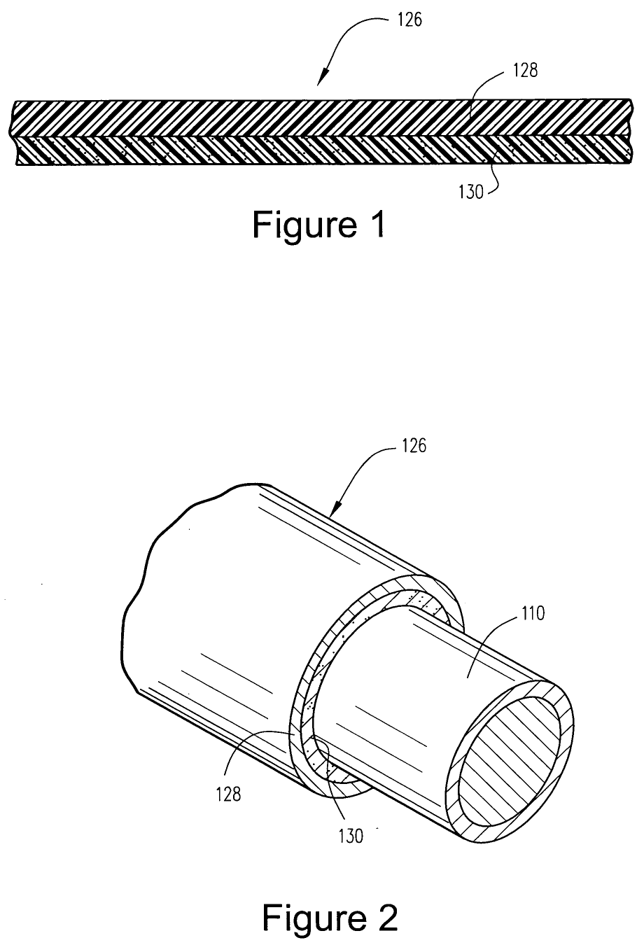

In accordance with the present invention, FIG. 1 illustrates a new and improved tape 126 having an outer layer 128 of PTFE and an inner layer 130 of a conductive coating comprising a metallic powder formed of copper, iron, nickel, aluminum, silver, gold or carbon, alone or in a suitable mixture, which is blended into a PTFE dispersion or ink solution in a ratio that, when cured at a sufficient temperature, provides a suitable conductive surface that bonds to the outer PTFE layer. The outer layer 128 may have a thickness of approximately 10 to 260 microns, and the inner layer 130 may have a thickness of approximately 7 to 130 microns. As will be explained more fully hereinafter, the tape 126 can be used as a conductive and insulation coating for the insulated electrical wire 110 as shown in FIG. 2 to provide a positive attenuation of and protection from electromagnetic and radio frequency interference. The insulated electrical wire 110 may have a diameter of approximately 0.005 to 1.000 inches. Also, the insulated electrical wire may be in the form of a single wire, or groups of wire formed into a round bundle or a flat ribbon structure.

The conductive and insulation tape 126 is used in place of separate conductive and insulation coatings on the insulated wire 110. The metallic powder in the inner layer 130 of the tape 126 may be blended in any suitable ratio (e.g., equal parts) with the PTFE liquid dispersion solution or liquid ink. Also, the metallic powder may be in a particle size of approximately 0.1 to 10 microns.

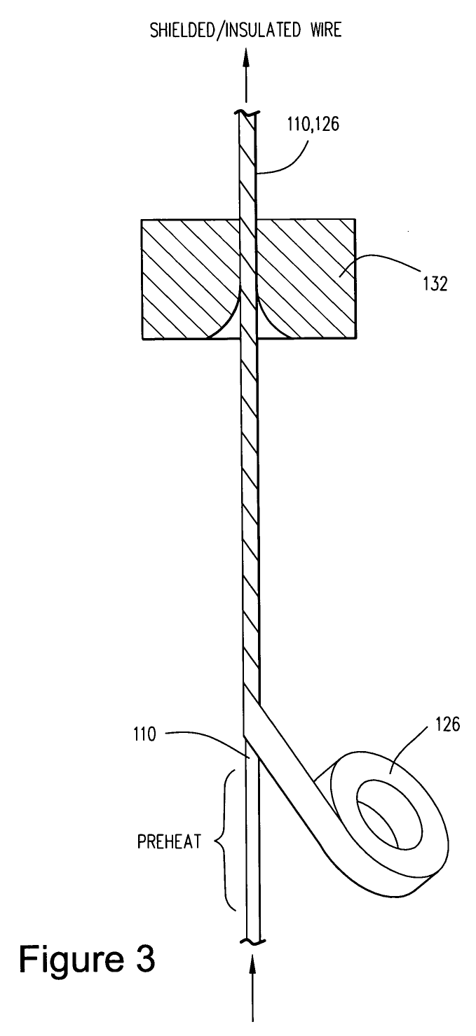

FIG. 3 illustrates schematically an apparatus for manufacturing the shielded electrical wire shown in FIG. 2. The insulated electrical wire 110 is preheated to approximately 650° F. and the conductive and insulation tape 126 is spirally wound thereon. The spirally wrapped wire is then passed through a metal compression sealer 132 or the like of any suitable construction wherein it is heated to approximately 800° F. to form and cure the conductive and insulation tape 126 as a coating on the insulated wire 110. In this manner, the tape 126 provides a conductive coating 130 on the wire 110 to attenuate and protect from electromagnetic and radio frequency interference. The tape 126 also provides an insulation coating 128 on the wire 110.

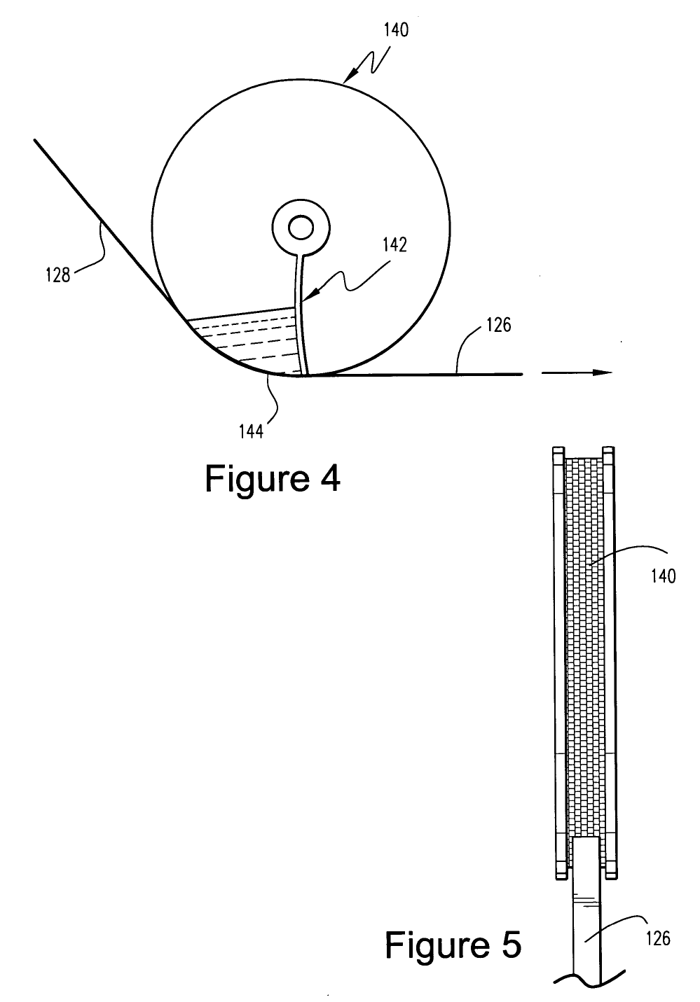

FIGS. 4-6 illustrate one embodiment of an apparatus for manufacturing the conductive and insulation tape 126 shown in FIGS. 1-3. As shown in FIGS. 4 and 5, the outer tape layer 128 is passed over a rotating silk screen reel 140 having a stationary squeegee 142 or the like for forming a reservoir 144 of the conductive coating comprising the metallic powder blended into a PTFE dispersion or ink solution to deposit the inner conductive layer 130 on the outer tape layer 128. Preferably, the outer tape layer 128 is cleaned by wiping it, e.g., with a paper towel saturated with isopropyl alcohol and then dried before passing it over the silk screen reel 140. The conductive tape layer 130 could be applied to the outer tape layer 128 by any other suitable method, such as brush coating or dip coating.

As an illustrative embodiment, the outer tape layer 128 may be passed over the rotating silk screen reel 140 at a speed of approximately 2 inches per second. The metallic powder/PTFE dispersion or ink solution in the reservoir 144 is maintained at a temperature of about 70° F.

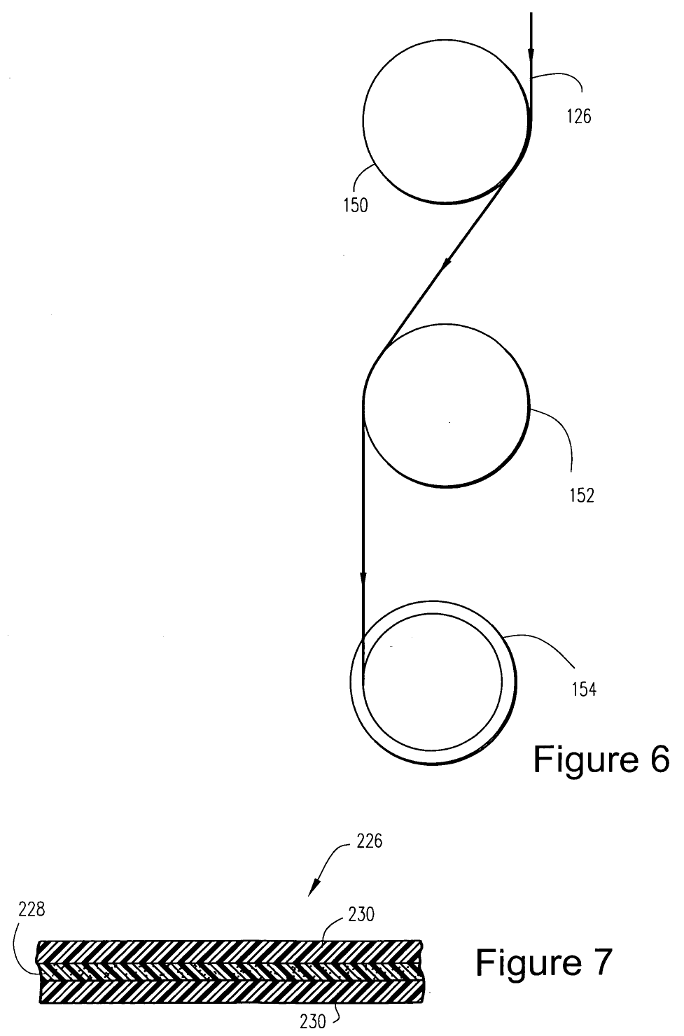

As shown in FIG. 6, the coated tape 126 leaving the silk screen reel 140 is cured by passing it over a pair of heated curing rings or mandrels 150 and 152. The outer layer 128 of the tape engages the first curing ring 150 which is heated to a temperature of about 650° F. to 750° F. The inner conductive layer 130 of the tape engages the second curing ring 152 which is heated to a temperature of about 650° F. to 750° F. The cured tape 126 is then wound on a take up spool 154. It is noted that the tape 126 may be cured in any other desired or suitable manner.

FIG. 7 illustrates a portion of a second embodiment of a conductive tape 226 of the present invention, which comprises an inner PTFE layer 228 and outer layers 230 of a conductive coating like that of the inner layer 130 of the conductive tape 126 shown in FIG. 1.

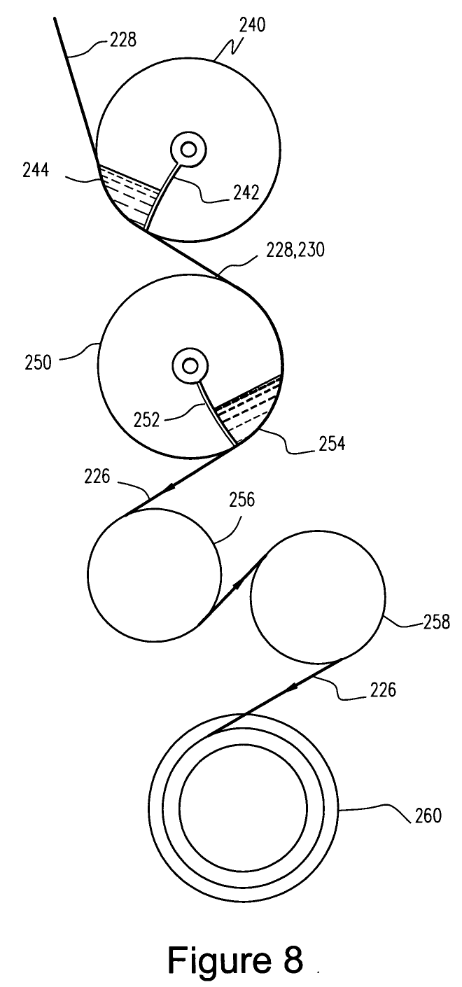

FIG. 8 illustrates one embodiment of an apparatus for manufacturing the conductive tape 226 shown in FIG. 7. The inner PTFE tape layer 228 is passed over a rotating silk screen reel 240 having a stationary squeegee 242 or the like for forming a reservoir 244 of the conductive coating comprising the metallic powder blended into a PTFE dispersion or ink solution to deposit the conductive layer 230 on one side of the inner tape layer 228. The coated tape 228, 230 is then passed over a second rotating silk screen reel 250 having a stationary squeegee 252 or the like for forming a reservoir 254 of the conductive coating comprising the metallic powder blended into a PTFE dispersion or ink solution to deposit the conductive layer 230 on the other side of the inner tape layer 228.

The coated conductive tape 226 leaving the silk screen 250 is then cured by passing it over a pair of heated curing rings or mandrels 256 and 258. The one outer conductive layer 230 of the tape engages the first curing ring 256 which is heated to a temperature of about 650° F. to 750° F. The other outer conductive layer 230 of the tape engages the second curing ring 258 which is heated to a temperature of about 650° F. to 750° F. The cured tape 226 is then wound on a take-up spool 260. It is noted that the tape 226 may be cured in any other desired or suitable manner.

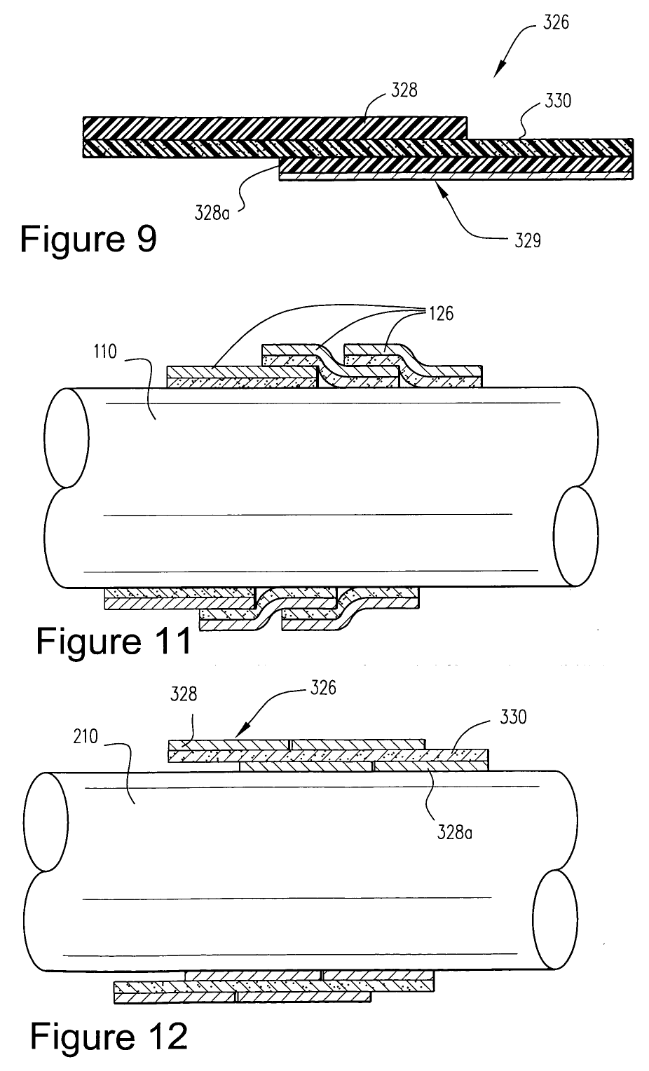

FIG. 9 is a side elevational view of a portion of a third embodiment of the conductive tape 326 of the present invention. In this embodiment, the tape 326 comprises an inner conductive layer 330 and outer PTFE layers 328, 328a that are offset laterally to expose upper and lower lateral end portions of the conductive layer 330. The inner PTFE layer 328a may be provided with adhesive with a slipsheet 329 on the inner surface thereof.

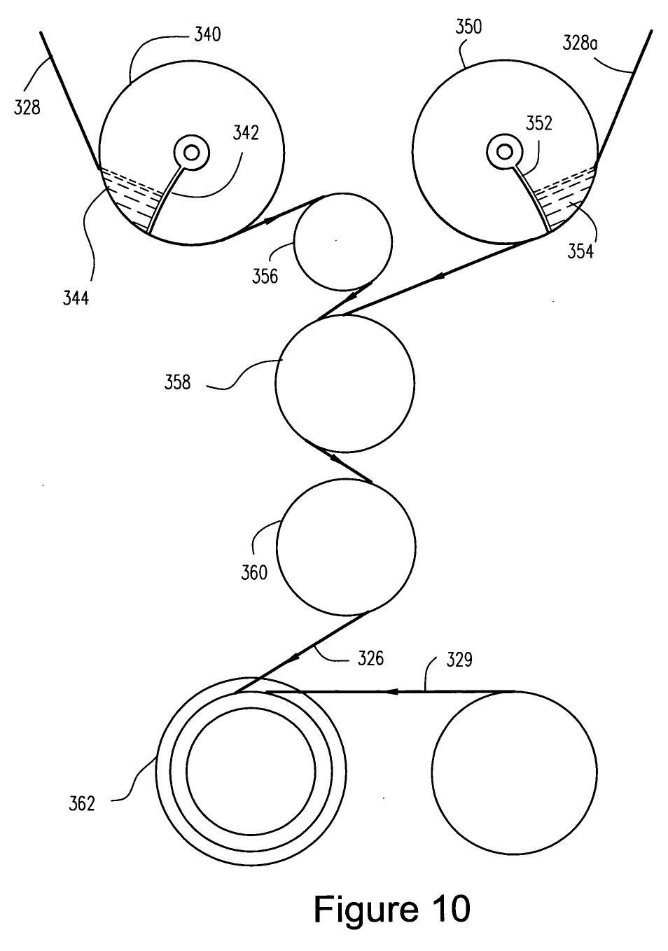

FIG. 10 is a side elevational view of one embodiment of an apparatus for manufacturing the conductive tape 326 shown in FIG. 9. The outer PTFE tape layer 328 is passed over a rotating silk screen reel 340 having a stationary squeegee 342 or the like for forming a reservoir 344 of the conductive coating comprising the metallic powder blended into a PTFE dispersion or ink solution to deposit the inner conductive layer 330 on the outer tape layer 328. The inner PTFE tape layer 328a is passed over a second rotating silk screen reel 350 having a stationary squeegee 352 or the like for forming a reservoir 354 of the conductive coating comprising the metallic powder blended into a PTFE dispersion or ink solution to deposit the inner conductive layer 330 on the inner tape layer 328a.

The coated outer PTFE tape layer 328 is then passed over a mandrel or ring 356 and then is overlapped with the second coated PTFE tape layer 328a in laterally offset relation as they are passed over a pair of curing rings or mandrels 358 and 360. The curing rings or mandrels 358, 360 are heated to a temperature of about 650° F. to 750° F. The cured conductive tape 326 is then wound on a take-up spool 362 and adhesive with slipsheet 329 may be applied to the inner surface of the inner PTFE layer 328a as it is wound on the take-up spool 362.

FIG. 11 illustrates the insulated electrical wire 110 with the conductive and insulation tape 126 spirally wound thereon in overlapping relation on a portion thereof. Similarly, FIG. 12 illustrates an insulated electrical wire 210 having the offset conductive tape 326 of FIG. 9 spirally wound on a portion thereof. It will be noted that the adjacent spiral windings of the conductive tape 326 are in overlapping and abutting relation to form substantially continuous inner and outer layers 328, 328a and 330.

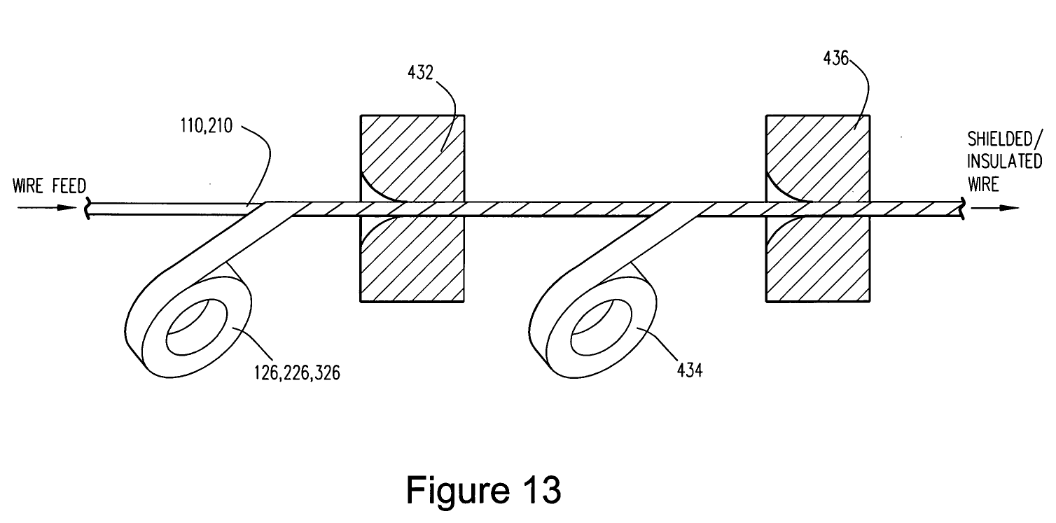

FIG. 13 is a view similar to FIG. 3 wherein the insulated electrical wire 110 or 210 is preheated to approximately 650° F. and the conductive tape 126, 226 or 326 is spirally wound thereon. The spirally wrapped wire is then passed through a metal compression sealer 432 or the like of any suitable construction wherein it is heated to approximately 800° F. to form and cure the conductive tape on the insulated wire. If additional insulation is desired, an insulating PTFE tape 434 may be spirally wrapped on the coated wire and then passed through a second metal compression sealer 436 to form and cure the insulating tape 434 on the coated wire. The second metal compression sealer is heated to approximately 800° F. The second insulating tape layer 434 may be especially useful with the conductive tape 226 shown in FIG. 7 which comprises outer conductive layers 230.

It will be readily seen from the foregoing description that the new and improved conductive tape and shielded electrical wire of the present invention are simple in construction, easy and inexpensive to manufacture, light in weight, small in diameter and of improved flexibility compared to the previously used metal shielded wire utilizing tapes, braids, foils or the like.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. (canceled)

2. The tape of claim 24 wherein said inner conductive layer comprises substantially equal parts of metallic powder and PTFE.

3. The tape of claim 24 wherein said metallic powder is selected from the group consisting of copper, iron, nickel, aluminum, silver, gold and carbon, alone or in combination.

4. The tape of claim 24 wherein it is constructed so that it can be spirally wound and cured on the insulated electrical wire.

5. A method of manufacturing the tape of claim 24 wherein said outer insulation layer is coated with said inner conductive layer, and said inner conductive layer is cured thereon.

6. The method of claim 5 wherein said inner conductive layer is heat-cured on said outer insulation layer.

7. The tape of claim 24 wherein an outer conductive layer is disposed on the outer surface of said insulation layer and is formed of metallic powder dispersed in a PTFE dispersion or ink solution.

8. (canceled)

9. The tape of claim 24 wherein an adhesive with slipsheet layer is disposed on the inner surface of said inner insulation layer.

10. The tape of claim 24 wherein said conductive layer is formed of metallic powder disposed in a PTFE dispersion or ink solution.

11. (canceled)

12. The shielded electrical wire of claim 25 wherein said conductive layer comprises substantially equal parts of metallic powder and PTFE.

13. The shielded electrical wire of claim 12 wherein said conductive layer is formed by dispersing said metallic powder in a PTFE solution, and heating and curing said metallic powder-PTFE mixture on said insulation layer of said tape to form said conductive layer thereon.

14. The shielded electrical wire construction of claim 25 wherein said metallic powder is selected from the group consisting of copper, iron, nickel, aluminum, silver, gold and carbon, alone or in combination.

15. The shielded electrical wire of claim 25 wherein said tape comprises a second conductive layer surrounding said second insulation layer.

16. (canceled)

17. (canceled)

18. (canceled)

19. (canceled)

20. (canceled)

21. (canceled)

22. (canceled)

23. (canceled)

24. A tape for shielding insulated electrical wire to provide a positive attenuation of and protection from electromagnetic and radio frequency interference, said tape comprising:
a conductive layer formed of metallic powder dispersed in PTFE;
an outer insulation layer formed of PTFE disposed on and bonded to the outer surface of said conductive layer; and
an inner insulation layer formed of PTFE disposed on and bonded to the inner surface of said conductive layer;
said inner and outer insulation layers being offset laterally with respect to each other to expose inner and outer lateral end portions of said conductive layer, thereby enabling the tape to be spirally wound on and bonded to the insulated with abutting insulation layers covering said lateral end portions of said conductive layer.

25. Shielded electrical wire, comprising:
insulated wire;
a first insulation layer formed of PTFE surrounding said insulated wire;
a conductive layer surrounding said first insulation layer to provide a positive attenuation of and protection from electromagnetic and radio frequency interference, said conductive layer comprising metallic powder dispersed in PTFE; and
a second insulation layer formed of PTFE surrounding said conductive layer;
said conductive layer and said insulation layers being formed by a tape having said layers bonded together that is spirally wound around and cured on said insulated wire;
said first and second insulation layers being offset laterally with respect to each other on opposite surfaces of said conductive layer to expose inner and outer lateral end portions thereof which are covered by abutting spirally wound insulation layers.
